(19) United States
(12) Patent Application Publication
(10) Pub. No.: US 2005/0250080 A1
(43) Pub. Date: Nov. 10, 2005

(54) Methods and computer program products for assessing language comprehension in infants and children

(75) Inventor: Margaret Friend, San Diego, CA (US)

Correspondence Address: MORRISON & FOERSTER LLP, 3811 VALLEY CENTRE DRIVE, SUITE 500, SAN DIEGO, CA, 92130-2332, US

(73) Assignee: San Diego State Univ. Foundation

(21) Appl. No.: 11/093,764

(22) Filed: Mar. 29, 2005

Related U.S. Application Data
(63) Continuation of application No. PCT/US03/31154, filed on Sep. 30, 2003.
(60) Provisional application No. 60/415,267, filed on Sep. 30, 2002.

(51) Int. Cl. G09B 19/00

(52) U.S. Cl. 434/236

(57) ABSTRACT

The invention provides methods for assessing early language comprehension in subjects such as children, infants or learning impaired individuals, and methods for assessing problem-solving and concept development in these subjects the invention also provides articles, or computer program products, comprising a machine-readable medium including machine-executable instructions and systems to practice the methods of the invention. In one aspect, touch-responsive surfaces are used to collect responses from subjects.

### RELATED APPLICATIONS

This application is a continuation of International Patent Application Serial No. PCT/US03/31154, filed Sep. 30, 2003, which claims the benefit of priority of U.S. Provisional Patent Application Ser. No. (“U.S. Ser. No.”) 60/415,267, filed Sep. 30, 2002. Each of the aforementioned applications are explicitly incorporated herein by reference in their entirety and for all purposes.

### FIELD OF THE INVENTION

This invention generally relates to the field of assessing human cognitive abilities. In particular, the invention provides methods for assessing early language comprehension in subjects, such as children, infants or learning impaired individuals, and methods for assessing problem-solving and concept development in these subjects. The invention also provides articles, or computer program products, comprising a machine-readable medium including machine-executable instructions and systems to practice the methods of the invention. In one aspect, touch-responsive surfaces, e.g., touch-screens, are used to collect responses from subjects.

### BACKGROUND OF THE INVENTION

Many attempts have been made to assess what children know in the second year of life before they are able to express that knowledge in language. Level of knowledge in the infants 12-20 months of age is especially important because it could provide an indication of other delays in the child's development that can only become apparent at older age. Moreover, Federal laws 99-457, e.g., Education of the Handicapped Act and Amendments, 1986, and 102-119, Individuals with Disabilities Education, 1991, mandate the identification of children from birth to age 3 who are at risk for developmental delay.

In this area, the majority of research on the acquisition of spoken language focuses on language production due to difficulties in assessing comprehension. Nevertheless, the study of language comprehension is a route to the concepts that underlie language production. In addition, the concurrent study of language comprehension and language production promises to provide a more complete picture of the language acquisition process than the study of language production alone. However, assessing language comprehension in young children has proved particularly difficult due to the absence of accurate, reliable and reproducible techniques and limitations in attention at younger ages.

Several techniques assessing infant's language comprehension have been developed in the past decade. Of particular interest is the MacArthur Communicative development Inventories: Words and Gestures (CDI) (see, e.g., Plomin (2002) J. Child Psychol. Psychiatry 43(5):619-633; Fenson (1994) Monogr. Soc. Res. Child Dev. 59(5):1-173; 174-185). It is a technique based on standardized measure of parent estimate of infant language comprehension. While the CDI generates extensive data, its reliability, validity and utility in predicting the course of language development are controversial. One of the reasons for inaccuracy of this technique is that parent estimation accounts for approximately 30-40% of the variance in child performance. As a result, it is desirable to substitute or supplement parent estimate of infant language comprehension with more precise performance-based measures of comprehension.

One technique that addresses this need utilizes the Comprehension Book (Ring, E. D., & Fenson, L. (2000) “The correspondence between parent report and child performance for receptive and expressive vocabulary beyond infancy,” First Language 20:141-159) a picture book used to assess infants' and toddlers' recognition of the relation between vocabulary items and their referents. Whereas this method presents a direct method of infant comprehension, it is a challenging task to maintain infant interest and attention while administering it to a child before 20 months of age. This difficulty in maintaining the attention of younger infants leads to an attenuation of estimates of vocabulary knowledge and of the relation between child performance and parent report.

A technique disclosed in U.S. Pat. No. 6,383,881 (Jenkins et al.) suggests a means for maintaining a person's interest in the continuing assessment of language comprehension, where motivation to continue is provided by periodic reward animations which include persistent plots and characters. Jenkins teaches a computer implemented training exercises which present stimuli to a user and receive responses by the user to the stimuli. While motivation provided by animated characters and persistent plots is likely to be effective for a user beginning around 10 to 12 years of age, it is not likely to be as successful with infants in the second year of life. Additionally, the technique disclosed in the above patent is directed to training exercise rather than assessing younger infant's language comprehension. Moreover, Jenkins technique utilizes user interfaces (e.g., joysticks, keyboards, etc.) that are not appropriate for use with infants or impaired individuals and does not utilize touch screen technology.

Known techniques for assessing infants' language comprehension are suited for their respective purposes but do not address the need for an accurate, reproducible and reliable technique that succeeds in keeping the infant's attention throughout administration of a test and that is easy to implement.

### SUMMARY OF THE INVENTION

The invention provides methods for evaluating a cognitive ability of a subject (e.g., a user such as a child, an infant, a disabled individual) comprising the following steps: (a) providing a touch-responsive surface, e.g., a touch screen; (b) presenting to the user a stimulus for a series of iterations; (c) presenting at least two sensory choices for response to the stimulus of the step (a), wherein the association of one of the choices to the stimulus is considered a correct response, (d) receiving a response to the stimulus from the user, and (e) determining whether the received response is correct for the stimulus by comparison of the response of the user to the stimuli to a predetermined correct response, wherein the cognitive ability of the user is evaluated by comparison of the responses of the user to the stimuli to the predetermined correct responses.

The invention provides methods for evaluating a cognitive ability of a subject (a user) comprising the following steps: (a) presenting to the user a stimulus for a series of iterations; (b) presenting at least two sensory choices for response to the stimulus of the step (a), wherein the association of one of the choices to the stimulus is considered a correct response, (c) receiving a response to the stimulus from the user, wherein the response from the user is provided by touching a touch-responsive surface, e.g., a computer screen, and (d) determining whether the received response is correct for the stimulus by comparison of the response of the user to the stimuli to a predetermined correct response, wherein the cognitive ability of the user is evaluated by comparison of the responses of the user to the stimuli to the predetermined correct responses.

In one aspect, the methods further comprise recording a correct response for the stimulus by coding as “1” in an output file and recording an incorrect response for the stimulus by coding as “0” in an output file. The methods can further comprise acknowledging receipt of the correct response for the stimulus by presenting to the user a verification representation. The methods can further comprise acknowledging receipt of the subsequent correct responses for the stimulus after the initial incorrect response by presenting to the user a verification representation, wherein subsequent correct responses for the stimulus after the initial incorrect response are not recorded.

In one aspect, the cognitive ability comprises language comprehension, such as preverbal or verbal language comprehension, or a combination thereof. In one aspect, the cognitive ability comprises problem solving, concept development ability or a combination thereof.

In one aspect, the subject (a “user”) is a developing child at the preverbal stage of development. The subject can be any age, including infants, children or adults. The subject can be normal, developmentally delayed, motor-impaired, cognitively impaired or disabled or having a condition or disease. As the methods provide a means to prognose (in addition to helping diagnose) conditions having a cognitive component, the subject can be an individual suspected of having a developmental delay, a motor-impairment, a cognitive impairment, a disability, a condition or a disease.

In alternative aspects, the stimulus is an auditory signal, a visual image (e.g., a movie, a cartoon, a video and the like), an olfactory signal, a physical signal, e.g., a contact with the subject, and the like.

The choice for a response from the subject (user) can be presented as a single image, as pairs of images, as three images or as at least four or more images (any plurality of images). The images can be static or animated, for example, videoclips, cartoons and the like. The images can comprise digital photographs, colored images and the like.

The choice for a response from the subject can be easy, moderate, or difficult. The methods can further comprise varying the choices for response by the user based on a cognitive ability evaluation. For example, the level of response (easy, moderate, or difficult) can be adjusted by the experimenter or by a program during the course of a testing regimen.

In one aspect, a correct response by the user subject produces a reinforcing signal. The reinforcing signal can be auditory or visual or a physical signal, e.g., a contact with the subject, and the like.

In one aspect, an incorrect response by the user does not produce a reinforcing signal. IN one aspect, a subsequent correct response produces a reinforcing signal. In one aspect, the choices for response are presented to the user for a limited period of time.

The invention provides a computer-implemented method for evaluating a cognitive ability of a user comprising the following steps (a) presenting to the user a stimulus for a series of iterations; (b) presenting to the user at least two sensory choices for response to the stimulus of the step (a), wherein the association of one of the choices to the stimulus is considered a correct response, (c) receiving a response to the stimulus from the user, wherein the user provides a response by touching a touch-responsive surface, e.g., a computer screen, (d) determining whether the received response is correct for the stimulus by comparison of the response of the user to the stimuli to a database storing predetermined correct response, wherein the cognitive ability of the user is evaluated by comparison of the responses of the user to the stimuli to a predetermined correct response and the evaluation is displayed to a user interface or is stored in a database.

In one aspect the method further comprises recording correct responses for the stimulus by coding them as “1” in an output file and acknowledging receipt of a correct response for the stimulus to the user by presenting a verification representation. The methods can further comprise recording incorrect responses for the stimulus by coding as “0” in the output file and acknowledging receipt of subsequent correct responses for the stimulus after the initial incorrect response by presenting to the user a verification representation.

The invention provides an article (e.g., a computer program product) comprising a machine-readable medium including machine-executable instructions, the instructions being operative to cause a machine to: present to a subject (a user) a stimulus; present to the subject at least two sensory choices for response to the stimulus of the step (a), wherein the association of one of the choices to the stimulus is considered a correct response, receive a response to the stimulus from the subject, wherein the subject provides a response by touching a touch-responsive surface, e.g., a computer screen, determine whether the received response is correct for the stimulus by comparison of the response of the subject to the stimuli to a database storing predetermined correct responses, wherein a cognitive ability of the subject is evaluated by comparison of the responses of the subject to the stimuli to a predetermined correct response and the evaluation is displayed to a user interface or is stored in a database.

The invention provides a computer system comprising an article (a computer program product) of the invention, a database having predetermined correct responses to stimuli; and a user interface allowing a user (e.g., an experimenter) to view the results of the evaluation of the cognitive ability.

All publications, patents, patent applications, GenBank sequences and ATCC deposits, cited herein are hereby expressly incorporated by reference for all purposes.

### DETAILED DESCRIPTION

The invention provides effective, reliable and accurate methods for assessing the cognitive abilities of an individual, such as a child, an infant or a disabled or learning impaired individual. The invention provides methods for evaluating a user's preverbal language comprehension. In one aspect, the method is used for infants in the second year of life before about 20 to 30 months of age. The level of knowledge or cognitive ability in an infant 12 to 20 months of age is especially important because it may provide an indication of other delays in the child's development that would otherwise only become apparent at an older age. Thus, the invention provides methods for prognosing conditions or diseases involving delays or deterioration in cognition. In another aspect, the methods of the invention can be used to evaluate problem solving or concept development ability.

Alternatively, the methods of the invention can be used for evaluations a cognitive ability of an older user with atypical development or conditions or diseases involving delays or deterioration in cognition. For example, autistic children show atypical development in joint attention and in referential pointing making traditional object and picture selection assessments of language comprehension ineffective. The invention provides the method allowing circumventing this limitation by associating reinforcing stimuli with the user's touch to a target object. From an assessment point of view, touching a picture and pointing to a picture are functionally equivalent behavioral responses. However, from a cognitive-developmental point of view, pointing to indicate reference is considerably more complex than touching something that produces a pleasing visual/auditory sensation. Thus, the invention provides an effective method for assessing language development or cognitive ability of a user.

Use of Touch-Responsive Surface Technology

In one aspect, the invention provides methods, including computer-implemented methods, for evaluating cognitive ability based on touch-responsive surfaces, e.g., touch-screen technology, such as a computer screen. A touch screen is a computer display screen that is sensitive to touch (e.g., an animals or a human touch), allowing a user to interact with the computer by touching words or pictures on the screen. In one aspect, the user is provided with the choice of pictures, images (e.g., movies, videos, cartoons), colors or words displayed on the screen. The subject touches the screen in response to auditory or other prompts from an experimenter. As noted below, any touch-screen can be used, e.g., a resistive touch-screen or a capacitive touch-screen.

The invention provides computer systems comprising touch-screens and in some aspects the methods of the invention involve the use of touch-screens. Any touch-screen or variation thereof can be used in the systems and methods of the invention. For example, for touch-responsive surfaces, touch-screens and methods of using them, see e.g., U.S. Pat. Nos. 6,278,444; 6,271,835; 6,154,210; 5,717,321 (describing an analog resistive touch screen powered by a current source responsive to a stored digital control value); U.S. Pat. Nos. 5,576,705; 5,565,657 (describing a user interface for accepting three dimensional information for input into a computer, printer, copier or other electronic device based on the pressure applied by an operator on the outer surface of an input pad); U.S. Pat. No. 5,228,562 (describing a membrane switch). The term “touch-screen” is used in its broadest sense. For example, a toy, such as a doll or ball, can have a touch responsive surface. Any touch-responsive surface is a touch-screen within the scope of the invention.

Engaging and Maintaining the Interest of a User

In practicing the methods of the invention, a stimulus is presented to a subject to elicit a response. In one aspect, the stimulus can be auditory and can come in the form of a question from a person conducting the evaluation test. In alternative aspects, the stimulus can be in visual, olfactory, gustatory or kinesthetic form or combination thereof. The choice for response to a stimulus can be presented in images on a touch screen. In one aspect, the images can be still pictures, for example, brightly colored photographs or pictures. In alternative aspects, the images can be animated pictures or video clips. In other aspects, the choice for response can be presented in pairs of images, or in the groups consisting of several images.

In one aspect, the invention provides at least two choices for response, one response being the correct one and all others incorrect. In one aspect, the correct response can be associated with the target image on the screen of the computer, while the incorrect responses can be associated with the distracters. Touching the target image on the screen can produce a reinforcing auditory signal that maintains interest of the user and motivates task compliance while touching the distracter does not. In an alternative aspect, touching the target image can produce a reinforcing visual signal. In another aspect, the combination of attractive visual and auditory stimuli can provide an engaging, user-friendly interface.

Evaluating the Cognitive Ability of the User

In one aspect of the invention, the choice for response can be presented in groups of images representing nouns, verbs, and adjectives. In one aspect, the images can appear simultaneously on the computer screen. An initial touch to the target image by the subject produces a reinforcing signal and is coded as a “1” in the output file. An initial touch to the distracter image does not produce a reinforcer and is coded as “0” in the output file. Subsequent touches are ignored with the reference to output file, but touches to the target continue to produce the reinforcing signal. If there is no touch during a trial, the trail is coded as missing“.” in the output file. In one aspect, the trial is repeated and the output for that trial is overwritten if an erroneous touch to the screen occurs.

In one aspect, the images presented for choice by a user consist of equal representation of easy, moderately difficult and difficult word groups or pairs. In one aspect, the procedure provides a forced-choice touch to one member of a pair of images in response to an experimenter's query (e.g., “Where is the diaper?”). In one aspect, there can be two forms of the procedure and the member of each pair of images that serves as the target is counterbalanced across forms. Within forms, the level of difficulty is matched within pairs and randomized across stimulus presentations.

In one aspect, target images appear with equal frequency on the right and left sides of the screen. In one aspect, the side on which the target appears is randomized across presentations with the restriction that targets appear no more than twice in succession on the same side. The order of item presentation and screen orientation can occur in any combination including, but not limited to, this pseudo-random sequence. In one aspect, the program produces a log-on screen, alternative stimulus presentation phases (for example, training, testing and reliability) and a data output file generated during the test and relativity phases. In one aspect, the invention provides standardizing the duration of the test trials by inserting a timer into the program for the purpose of eliminating the influence of extraneous touches to the screen and standardizing the duration of the trial.

Computer Systems and Computer Program Products

The invention provides articles (e.g., computer program products) comprising a machine-readable medium including machine-executable instructions, computer systems and computer implemented methods to practice the methods of the invention. Accordingly, the invention provides computer, computer systems, computer readable mediums, computer programs products and the like having recorded or stored thereon machine-executable instructions to practice the methods of the invention. As used herein, the words “recorded” and “stored” refer to a process for storing information on a computer medium. A skilled artisan can readily adopt any known methods for recording information on a computer to practice the methods of the invention. The methods of the invention can be practiced using any program language or computer/processor and in conjunction with any known software or methodology.

Another aspect of the invention is a computer readable medium having recorded thereon machine-executable instructions to practice the methods of the invention. Computer readable media include magnetically readable media, optically readable media, electronically readable media and magnetic/optical media. For example, the computer readable media may be a hard disk, a floppy disk, a magnetic tape, CD-ROM, Digital Versatile Disk (DVD), Random Access Memory (RAM), or Read Only Memory (ROM) as well as other types of other media known to those skilled in the art.

The computer/processor used to practice the methods of the invention can be a conventional general-purposes digital computer, e.g., a personal “workstation” computer, including conventional elements such as microprocessor and data transfer bus. The computer/processor can further include any form of memory elements, such as dynamic random access memory, flash memory or the like, or mass storage such as magnetic disc optional storage. For example, a conventional personal computer such as those based on an Intel microprocessor and running a Windows operating system can be used. Any hardware or software configuration can be used to practice the methods of the invention. For example, computers based on other well-known microprocessors and running operating system software such as UNIX, Linux, MacOS and others are contemplated. As used herein, the terms “computer,” “computer program” and “processor” are used in their broadest general contexts and incorporate all such devices.

A number of embodiments of the invention have been described. Nevertheless, it will be understood that various modifications may be made without departing from the spirit and scope of the invention. Accordingly, other embodiments are within the scope of the following claims.

1. A method for evaluating a cognitive ability of a user comprising the following steps:
(a) providing a touch screen;
(b) presenting to the user a stimulus for a series of iterations;
(c) presenting at least two sensory choices for response to the stimulus of the step
(a), wherein the association of one of the choices to the stimulus is considered a correct response,
(d) receiving a response to the stimulus from the user, and
(e) determining whether the received response is correct for the stimulus by comparison of the response of the user to the stimuli to a predetermined correct response,
wherein the cognitive ability of the user is evaluated by comparison of the responses of the user to the stimuli to the predetermined correct responses: or comprising the s of
(a) Resenting to the user a stimulus for a series of iterations;
(b) presenting at least two sensory choices for response to the stimulus of the step (a), wherein the association of one of the choices to the stimulus is considered a correct response.
(c) receiving a response to the stimulus from tee user wherein the response from the user is provided by touching a computer screen, and
(d) determining whether the received response is correct for the stimulus by comparison of the user to the stimuli to a predetermined correct response
wherein the cognitive ability of the user is evaluated by comparison of the responses of the user to the stimuli to the predetermined correct responses.

2. (canceled)

3. The method of claim 1, further comprising recording a correct response for the stimulus by coding as “1” in an output file and recording an incorrect response for the stimulus by coding as “0” in an output file.

4. The method of claim 1, further comprising acknowledging receipt of the correct response for the stimulus by presenting to the user a verification representation

5. The method of claim 3, further comprising acknowledging receipt of the subsequent correct responses for the stimulus after the initial incorrect response by presenting to the user a verification representation, wherein subsequent correct responses for the stimulus after the initial incorrect response are not recorded.

6. The method of claim 1, wherein the cognitive ability comprises a language comprehension.

7. The method of claim 6, wherein the language comprehension comprises a preverbal language comprehension.

8. The method of claim 1, wherein the cognitive ability comprises problem solving or concept development ability.

9. The method of claim 1, wherein the user is a normally developing child.

10. The method of claim 9, wherein the normally developing child is at the preverbal stage of development.

11. The method of claim 1, wherein the user is developmentally delayed, motor-impaired or cognitively impaired

12. The method of claim 1, wherein the stimulus is an auditory signal, a visual signal or a combination thereof.

13. The method of claim 13, wherein the choice for response from the user is presented as a single image, as pairs of images, as three images or as at least four or more images.

14. The method of claim 13, wherein the images are static, are animated, are videoclips, are cartoons, comprise digital photographs, comprise colored images or a combination thereof.

15-19. (canceled)

20. The method of claim 1, wherein the choice for response from the user is easy, moderate, or difficult.

21. The method of claim 1, further comprising varying the choices for response by the user based on a cognitive ability evaluation.

22. The method of claim 1, wherein a correct response by the user produces a reinforcing signal.

23. The method of claim 22, wherein the reinforcing signal is auditory or visual.

24. The method of claim 1, wherein an incorrect response by the user does not produce a reinforcing signal, or, a subsequent correct response produces a reinforcing signal, or a subsequent correct response produces a reinforcing signal, or the choices for response are presented to the user for a limited period of time.

25-26. (canceled)

27. A computer-implemented method for evaluating a cognitive ability of a user comprising the following steps
(a) presenting to the user a stimulus for a series of iterations;
(b) presenting to the user at least two sensory choices for response to the stimulus of the step (a), wherein the association of one of the choices to the stimulus is considered a correct response,
(c) receiving a response to the stimulus from the user, wherein the user provides a response by touching a computer screen, and
(d) determining whether the received response is correct for the stimulus by comparison of the response of the user to the stimuli to a database storing predetermined correct responses, wherein the cognitive ability of the user is evaluated by comparison of the responses of the user to the stimuli to a predetermined correct response and the evaluation is displayed to a user interface or is stored in a database.

28. The method of claim 27 further comprising recording correct responses for the stimulus by coding them as “1” in an output file and acknowledging receipt of a correct response for the stimulus to the user by presenting a verification representation.

29. The method of claim 27 further comprising recording incorrect responses for the stimulus by coding them as “0” in the output file and acknowledging receipt of subsequent correct responses for the stimulus after the initial incorrect response by presenting to the user a verification representation.

30. An article comprising a machine-readable medium including machine-executable instructions, the instructions being operative to cause a machine to:
(a) present to a user a stimulus;
(b) present to the user at least two sensory choices for response to the stimulus of the step (a), wherein the association of one of the choices to the stimulus is considered a correct response,
(c) receive a response to the stimulus from the user, wherein the user provides a response by touching a computer screen, and
(d) determine whether the received response is correct for the stimulus by comparison of the response of the user to the stimuli to a database storing predetermined correct response, wherein a cognitive ability of the user is evaluated by comparison of the responses of the user to the stimuli to a predetermined correct response and the evaluation is displayed to a user interface or is stored in a database,

31. A computer system comprising:
(a) an article as set fort in claim 30;
(b) a database having predetermined correct responses to stimuli; and
(c) a user interface allowing a user to view the results of the evaluation of the cognitive ability.
